(19) United States
(12) Patent Application Publication
(10) Pub. No.: US 2022/0229015 A1
(43) Pub. Date: Jul. 21, 2022

(54) MICROCHIP ELECTROPHORESIS METHOD AND MICROCHIP ELECTROPHORESIS DEVICE

(71) Applicant: SHIMADZU CORPORATION, Kyoto (JP)

(72) Inventors: Hidesato KUMAGAI, Kyoto (JP); Akihiro ARAI, Kyoto (JP); Akira HARADA, Kyoto (JP)

(73) Assignee: SHIMADZU CORPORATION, Kyoto (JP)

(21) Appl. No.: 17/611,366

(22) PCT Filed: Jan. 14, 2020
(86) PCT No.: PCT/JP2020/000838

§ 371 Date: Jan. 20, 2022

(30) Foreign Application Priority Data
May 17, 2019 (JP) 2019-093668

(51) Int. Cl. G01N 27/447

(52) U.S. Cl. CPC G01N 27/44791; G01N 2550/00

(57) ABSTRACT

A microchip electrophoresis method includes sequentially analyzing a plurality of samples by repeating an analysis process by electrophoresis separation in a microchip, executing a cleaning process of the microchip, and setting timing of the cleaning process of the microchip at arbitrary timing between a plurality of analysis processes.

### TECHNICAL FIELD

The present invention relates to a microchip electrophoresis method and a microchip electrophoresis device.

### BACKGROUND ART

An electrophoresis device separates a trace sample at high speed by an electrophoresis method using a device such as a microchip or a capillary. For example, Japanese Patent Laying-Open No. 2012-251821 (PTL 1) discloses a microchip electrophoresis device. The microchip is configured by joining a base substrate in which a flow channel in which electrophoresis separation is executed and a flow channel in which a sample is introduced are formed and a base substrate on which a through-hole functioning as a reservoir for the sample and the separation medium is formed.

In the microchip electrophoresis device described in PTL 1, analysis cost is reduced by repeatedly using the microchip. On the other hand, when the microchip is repeatedly used, the component contained in the sample of previous analysis or the component contained in a separation medium is adsorbed on a surface of the flow channel, and thus, there is a concern that analysis performance is degraded as the number of use times increases. For this reason, in PTL 1, the analysis performance is recovered by executing a cleaning process of cleaning the flow channel of the microchip with a cleaning liquid before starting a plurality of analysis processes in the microchip, for each analysis process, or after the plurality of analysis processes.

### CITATION LIST

### Patent Literature

PTL 1: Japanese Patent Laying-Open No. 2012-251821

### SUMMARY OF INVENTION

### Technical Problem

When a plurality of samples per operation are analyzed in the microchip electrophoresis device described above, even if the cleaning process is performed before the start of the analysis of the plurality of samples, the analysis performance may gradually decrease as the analysis of the samples progresses. In such a case, there is a concern that data having the low analysis performance and low analysis reproducibility may be acquired by repeatedly performing the analysis in a state where the analysis performance is degraded. In addition, there is a concern that the sample is wastefully consumed by acquiring such data.

On the other hand, when the cleaning process is performed every time the analysis of one sample is completed, a decrease in the analysis performance can be suppressed, but there is a concern that it takes a long time to complete the analysis of all the samples.

The present invention has been made to solve such a problem, and an object of the present invention is to provide a microchip electrophoresis method and a microchip electrophoresis device capable of efficiency suppressing the decrease in the analysis performance when the microchip is repeatedly used.

### Solution to Problem

A first aspect of the present invention is a microchip electrophoresis method including: sequentially analyzing a plurality of samples by repeating an analysis process by electrophoresis separation on a microchip; executing a cleaning process of the microchip; and setting timing of the cleaning process of the microchip at arbitrary timing between a plurality of times of the analysis process.

A second aspect of the present invention relates to a microchip electrophoresis device. The microchip electrophoresis device includes a microchip in which an electrophoresis flow channel is formed, a dispensing probe, a moving mechanism, a filling and discharging unit, and a controller. The dispensing probe is configured to inject a separation medium, a sample, and a cleaning liquid into the electrophoresis flow channel of the microchip. The moving mechanism moves the dispensing probe between suction positions of the separation medium, the sample, and the cleaning liquid and a dispensing position on the microchip. The filling and discharging unit is configured to fill the separation medium and the cleaning liquid into the electrophoresis flow channel and discharge the separation medium and the cleaning liquid from the electrophoresis flow channel. The controller controls operations of the dispensing probe, the movement mechanism, and the filling and discharging unit. The controller is configured to repeatedly execute an analysis process by electrophoresis separation on the microchip and execute a microchip cleaning process. The controller is communicably connected to an input unit that receives an input operation for setting timing of the cleaning process of the microchip at arbitrary timing between a plurality of analysis processes.

### Advantageous Effects of Invention

According to the present invention, it is possible to provide a microchip electrophoresis method and a microchip electrophoresis device capable of efficiently suppressing a decrease in analysis performance when a microchip is repeatedly used.

### BRIEF DESCRIPTION OF DRAWINGS

FIG. 1 is a view schematically illustrating an overall configuration of a microchip electrophoresis device according to an embodiment of the present invention.

FIG. 2 is a view schematically illustrating a configuration of a main part of the microchip electrophoresis device in FIG. 1.

FIG. 3 is a block diagram illustrating a control configuration of a controller in FIG. 1.

FIG. 4 is a view illustrating an example of a microchip.

FIG. 5 is a view illustrating the example of the microchip.

FIG. 6 is a view schematically illustrating a connection state between an air supply port of a separation buffer filling and discharging unit and the microchip.

FIG. 7 is a perspective view illustrating a cleaning process in process order.

FIG. 8 is a perspective view illustrating an analysis process in process order.

FIG. 9 is a perspective view illustrating the analysis process in the process order.

FIG. 10 is a perspective view illustrating the analysis process in the process order.

FIG. 11 is a flowchart illustrating a processing procedure of the analysis process.

FIG. 12 is a flowchart illustrating a processing procedure of the microchip electrophoresis method of the embodiment.

FIG. 13 is a flowchart illustrating a flow of analysis schedule registration processing.

FIG. 14 is a view illustrating an example of an analysis schedule input screen.

FIG. 15 is a view illustrating an example of an analysis result.

FIG. 16 is a flowchart illustrating a processing flow of automatic analysis.

FIG. 17 is a flowchart illustrating a first example of processing in step S32 in FIG. 16.

FIG. 18 is a flowchart illustrating a second example of the processing of step S32 in FIG. 16.

### DESCRIPTION OF EMBODIMENTS

With reference to the drawings, an embodiment of the present invention will be described in detail below. In the drawings, the same or corresponding portions are denoted by the same reference numeral, and the description will not be repeated in principle.

[Configuration of Microchip Electrophoresis Device]

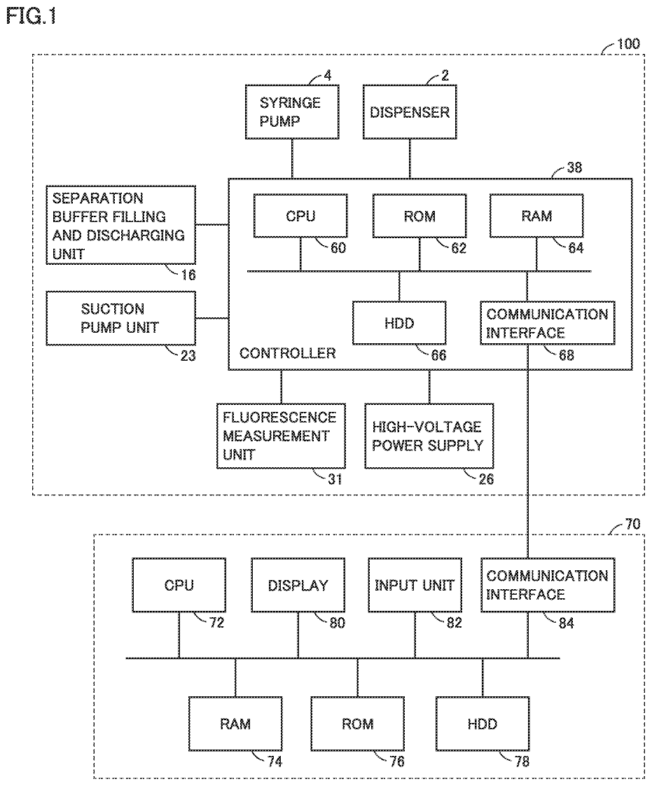

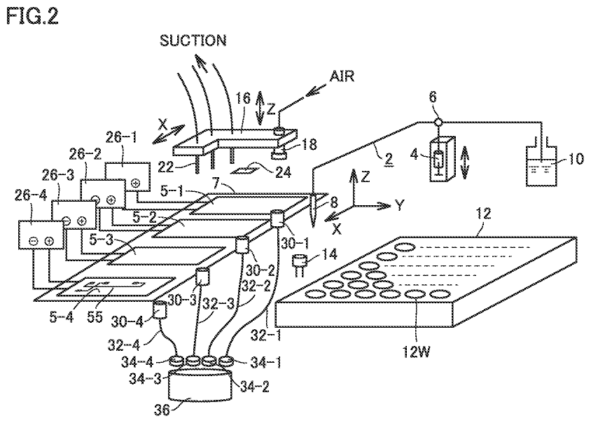

FIG. 1 is a view schematically illustrating an overall configuration of a microchip electrophoresis device 100 according to an embodiment of the present invention. FIG. 2 is a view schematically illustrating a configuration of a main part of microchip electrophoresis device 100 in FIG. 1.

Referring to FIG. 1, microchip electrophoresis device 100 includes a dispenser 2, a syringe pump 4, a separation buffer filling and discharging unit 16, a suction pump unit 23, a high-voltage power supply 26, a fluorescence measurement unit 31, and a controller 38. Microchip electrophoresis device 100 is communicably connected to a control device 70.

Referring to FIG. 2, microchip electrophoresis device 100 further includes a plurality of (for example, four) microchips 5-1 to 5-4, a holding unit 7, and a microtiter plate 12.

In each of microchips 5-1 to 5-4, one electrophoresis flow channel is formed in order to process one sample. During the analysis operation, microchips 5-1 to 5-4 are held by holding unit 7. Hereinafter, sometimes microchips 5-1 to 5-4 are collectively referred to as a microchip 5. Microchip 5 can be repeatedly used.

Dispenser 2 is configured to dispense a separation buffer liquid and the sample into microchips 5-1 to 5-4. The separation buffer solution is also used as a “separation medium”, and for example, contains at least one of a pH buffer and a water-soluble polymer (such as a cellulose-based polymer). Dispenser 2 constitutes a “moving mechanism” that moves a dispensing probe 8 between a suction position of a liquid to be dispensed and a dispensing position on microchip 5. Specifically, dispenser 2 includes dispensing probe 8, syringe pump 4, at least one container 10 that holds at least one type of cleaning liquid, and a three-way solenoid valve 6.

Dispensing probe 8 includes a dispensing nozzle. Syringe pump 4 sucks and discharges the separation buffer liquid, the sample, or the cleaning liquid. Dispensing probe 8 and at least one container 10 are connected to syringe pump 4 through three-way solenoid valve 6.

The sample is accommodated in a well 12W on microtiter plate 12 and dispensed into microchips 5-1 to 5-4 by dispenser 2. The separation buffer liquid is accommodated in a container (not illustrated) and dispensed into microchips 5-1 to 5-4 by dispenser 2.

Separation buffer filling and discharging unit 16 and suction pump unit 23 constitute a buffer liquid filling mechanism that fills the electrophoresis flow channel of microchip 5 with the separation buffer liquid. Separation buffer filling and discharging unit 16 injects a certain amount of separation buffer liquid into one reservoir of the electrophoresis flow channel, and fills pneumatically the electrophoresis flow channel with the injected separation buffer liquid from the reservoir Separation buffer filling and discharging unit 16 includes an air supply port 18 and a suction nozzle 22. Suction pump unit 23 discharges the unnecessary separation buffer liquid overflowing into another reservoir. Separation buffer filling and discharging unit 16 and suction pump unit 23 are provided in common for four microchips 5-1 to 5-4.

Dispenser 2 sucks the separation buffer liquid or the sample into dispensing probe 8 by connecting three-way solenoid valve 6 in a direction in which dispensing probe 8 and syringe pump 4 are connected. When moving dispensing probe 8 onto microchips 5-1 to 5-4, dispenser 2 discharges dispensing probe 8 to the reservoir of any one of the electrophoresis flow channels of microchips 5-1 to 5-4 by syringe pump 4.

A cleaning unit 14 is used for cleaning dispensing probe 8 and filled with a cleaning liquid.

When dispensing probe 8 is cleaned, dispenser 2 switches three-way solenoid valve 6 to a direction in which syringe pump 4 and container 10 for the cleaning solution are connected, and sucks the cleaning solution into syringe pump 4.

Subsequently, dispenser 2 immerses dispensing probe 8 in the cleaning solution of cleaning unit 14, switches three-way solenoid valve 6 to a side connecting syringe pump 4 and dispensing probe 8, and discharges the cleaning solution from an inside of dispensing probe 8, thereby cleaning dispensing probe 8.

When the electrophoresis flow channels of microchips 5-1 to 5-4 are cleaned, dispenser 2 switches to a direction in which three-way solenoid valve 6 and syringe pump 4 are connected to container 10, and sucks the cleaning liquid into syringe pump 4. Dispenser 2 moves dispensing probe 8 to the reservoirs of microchips 5-1 to 5-4 and dispenses a predetermined amount of cleaning liquid into the reservoirs. The cleaning liquid dispensed into the reservoir enters the electrophoresis flow channel by a capillary phenomenon.

Separation buffer filling and discharging unit 16 is also used when the cleaning solution is discharged after held for a predetermined time in the state where the cleaning solution is contained in the electrophoresis flow channel.

When the separation buffer liquid is filled in the electrophoresis flow channel, separation buffer filling and discharging unit 16 moves onto microchips 5-1 to 5-4, presses air supply port 18 against the reservoir (the reservoir into which the separation buffer liquid is dispensed) at one end of the electrophoresis flow channel of microchips 5-1 to 5-4 in an airtight manner, and inserts suction nozzle 22 into another reservoir. In this state, air is blown from air supply port 18 to push the separation buffer liquid into the electrophoresis flow channel, and the separation buffer liquid overflowing from another reservoir is sucked from suction nozzle 22 by suction pump unit 23 and discharged to the outside. The same applies to the case of discharging the cleaning liquid in the electrophoresis flow channel, and air supply port 18 is pressed against the reservoir at one end of microchips 5-1 to 5-4 in the airtight manner, and suction nozzle 22 is inserted into another reservoir. In this state, air is blown from the air supply port 18 to push the cleaning solution into the electrophoresis flow channel, and the cleaning solution overflowing from another reservoir is sucked from suction nozzle 22 by suction pump unit 23 and discharged to the outside.

High-voltage power supply 26 includes a plurality of (for example, four) independent high-voltage power supplies 26-1 to 26-4 for each microchip 5 in order to independently apply an electrophoresis voltage to the electrophoresis flow channels of microchips 5-1 to 5-4.

Fluorescence measurement unit 31 is configured to detect sample components electrophoresis-separated in separation flow channel 55 of each of microchips 5-1 to 5-4. Specifically, fluorescence measurement unit 31 includes a plurality of (for example, 4) LEDs (Liquid Emitting Diodes) 30-1 to 30-4, a plurality of (for example, 4) optical fibers 32-1 to 32-4, a plurality of (for example, 4) filters 34-1 to 34-4, and a photomultiplier tube 36.

Each of the LEDs 30-1 to 30-4 irradiates a part of the electrophoresis flow channel of each of microchips 5-1 to 5-4 with excitation light. Optical fibers 32-1 to 32-4 receive fluorescence generated when sample components moving in the electrophoresis flow channel are excited by the excitation light from LEDs 30-1 to 30-4. Filters 34-1 to 34-4 remove an excitation light component from the fluorescence from optical fibers 32-1 to 32-4 and transmit only a fluorescence component.

Photomultiplier tube 36 receives the fluorescence component transmitted through filters 34-1 to 34-4.

In the embodiment, filters 34-1 to 34-4 transmit different fluorescence. Accordingly, different types of fluorescence can be detected among microchips 5-1, 5-2, 5-3, 5-4.

However, when the same fluorescence is detected in microchips 5-1 to 5-4, one filter can be used in common. By causing LEDs 30-1 to 30-4 to emit light with time shifted from each other, the fluorescence from the plurality of microchips 5-1 to 5-4 can be identified and detected by one photomultiplier tube 36. The light source of the excitation light is not limited to the LED, but a laser diode (LD) may be used.

When the filling of the separation buffer liquid and the sample injection into one electrophoresis flow channel are completed, controller 38 controls the operation of dispenser 2 so as to shift to the filling of the next separation buffer liquid and the next sample injection into the electrophoresis flow channel. Controller 38 controls the operation of high-voltage power supply 26 (high-voltage power supplies 26-1 to 26-4) such that the electrophoresis is caused by applying the electrophoresis voltage in the electrophoresis flow channel in which the sample injection is completed. Controller 38 controls the detection operation of fluorescence measurement unit 31. In order to repeatedly use microchip 5, controller 38 further controls the cleaning operation of the electrophoresis flow channel before filling the electrophoresis flow channel in which the analysis of the previous sample is completed with the separation buffer liquid.

Controller 38 includes a central processing unit (CPU) 60, a storage in which stores programs and data are stored, and a communication interface (I/F) 68 as main components. The components are connected to each other by a data bus.

The storage includes a read only memory (ROM) 62, a random access memory (RAM) 64, and a hard disk drive (HDD) 66. ROM 62 can store a program executed by CPU 60. RAM 64 can temporarily store data generated by execution of a program in CPU 60 and data input through communication I/F 68, and can function as a temporary data memory used as a work area. HDD 66 is a nonvolatile storage device, and can store information generated by microchip electrophoresis device 100 such as the detection result of fluorescence measurement unit 31. Alternatively, a semiconductor storage device such as a flash memory may be adopted instead of HDD 66.

Communication I/F 68 is an interface that communicates with an external device including control device 70. The communication I/F is implemented by an adapter, a connector, or the like. For example, the communication method may be wireless communication such as Bluetooth (registered trademark) or a wireless local area network (LAN), or wired communication using a universal serial bus (USB) or the like.

Control device 70 is communicably connected to microchip electrophoresis device 100, and exchanges data with microchip electrophoresis device 100. Control device 70 is configured to control the operation of microchip electrophoresis device 100 and capture and process the data acquired by fluorescence measurement unit 31.

Specifically, control device 70 is mainly configured by a CPU 72 that is an arithmetic processing unit. For example, a personal computer or the like can be used as control device 70. Control device 70 includes CPU 72, a storage (ROM 76, RAM 74, and HDD 78), a communication I/F 84, an input unit 82, and a display 80.

ROM 76 can store a program executed by CPU 72. RAM 74 can temporarily store data generated by execution of a program in CPU 72 and data input through communication I/F 84 or input unit 82, and can function as a temporary data memory used as a work area. HDD 78 is a nonvolatile storage device, and can store information generated by control device 70. Alternatively, a semiconductor storage device such as a flash memory may be adopted instead of the HDD 78.

Communication I/F 84 is an interface through which control device 70 communicates with an external device including microchip electrophoresis device 100. Input unit 82 receives an input operation including an instruction for microchip electrophoresis device 100 from a measurer Input unit 82 includes a keyboard, a mouse, a touch panel integrally formed with a display screen of display 80, and the like. As described later, input unit 82 receives registration of an analysis schedule for sequentially analyzing a plurality of samples, and receives an instruction on the timing of the cleaning process of microchip 5.

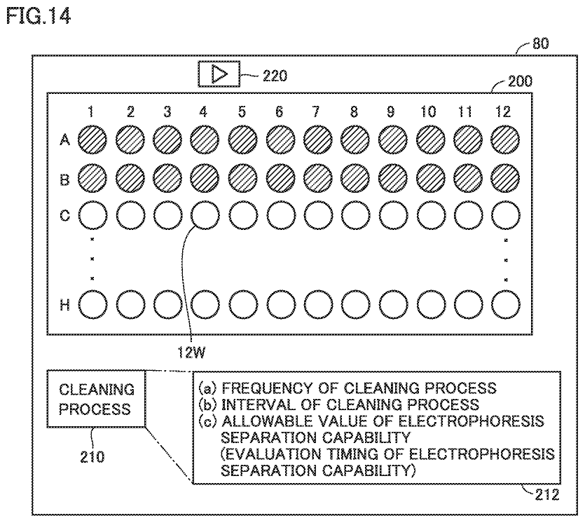

Display 80 can display the input screen of the analysis schedule when the analysis schedule is registered (see FIG. 14). When the timing of the cleaning process of microchip 5 is instructed, display 80 can display the input screen of the timing of the cleaning process (see FIG. 14). During or after the analysis measurement, display 80 can display detection data by fluorescence measurement unit 31, analysis results for each sample, and the like.

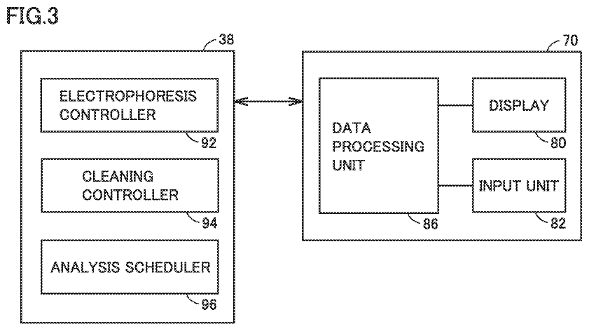

FIG. 3 is a block diagram illustrating a control configuration of controller 38 in FIG. 1.

Referring to FIG. 3, controller 38 includes an electrophoresis controller 92, a cleaning controller 94, and an analysis scheduler 96. These functional configurations are implemented by CPU 60 executing a predetermined program in microchip electrophoresis device 100 of FIG. 1.

Electrophoresis controller 92 repeatedly executes an analysis process by electrophoresis for each microchip 5. The analysis process includes (1) a buffer liquid filling process of filling an empty electrophoresis flow channel with a separation buffer liquid, (2) a sample dispensing process of dispensing a sample into a reservoir for sample supply, (3) an electrophoresis separation process of executing the electrophoresis separation of the sample in the separation flow channel by applying the electrophoresis voltage between a plurality of reservoirs, and (4) a buffer liquid removing process of supplying pressurized gas from one reservoir and sucking the separation buffer liquid from another reservoir to remove the separation buffer liquid in the electrophoresis flow channel and the reservoir.

Cleaning controller 94 executes at least one cleaning process for each microchip 5. The cleaning process includes, using at least one type of cleaning solution held in at least one container 10, (1) a process of supplying a certain amount of cleaning solution to one reservoir while the electrophoresis flow channel and the reservoir are empty, (2) a process of introducing the cleaning solution into the electrophoresis flow channel by the capillary phenomenon while the cleaning solution is held for a certain period of time, and (3) a process of supplying pressurized gas from one reservoir and sucking the cleaning solution from another reservoir to remove the cleaning solution in the electrophoresis flow channel and the reservoir. The at least one type of cleaning liquid includes water or a cleaning liquid other than water (such as a cleaning liquid containing an organic solvent or a surfactant).

Analysis scheduler 96 determines execution order of a plurality of analysis processes and at least one cleaning process for each microchip 5. Analysis scheduler 96 allocates processing resources (program time, memory, and the like) to electrophoresis controller 92 and cleaning controller 94 in accordance with the previously-registered analysis schedule and cleaning process timing.

Control device 70 includes a data processing unit 86. When receiving the instruction from input unit 82, data processing unit 86 transmits data indicating the instruction content to controller 38. When receiving the detection data by fluorescence measurement unit 31 from controller 38, data processing unit 86 processes the received detection data and displays the processing result on display 80.

[Configuration Example of Microchip 5]

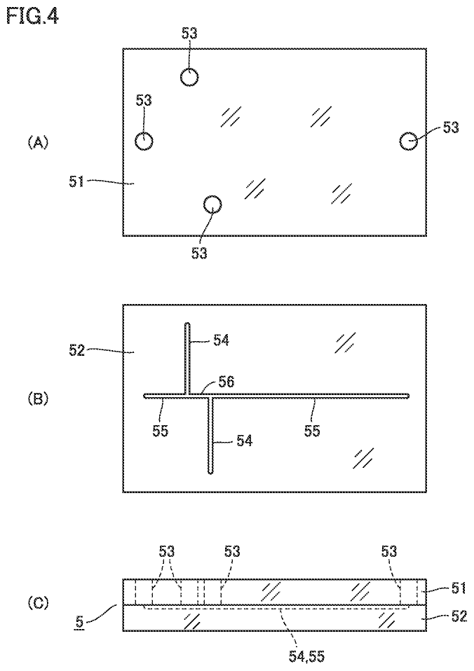

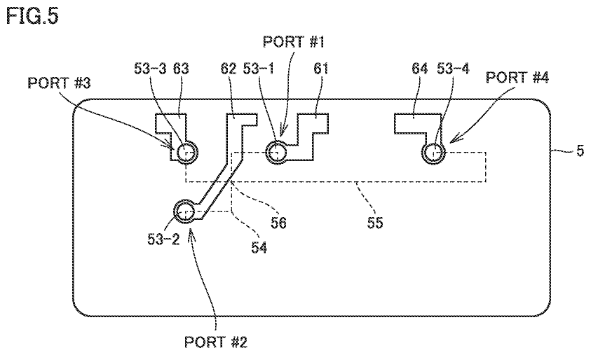

FIGS. 4 and 5 are views illustrating an example of microchip 5. In the specification, the “microchip” means a device for electrophoresis in which the electrophoresis flow channel is formed in the substrate, and is not necessarily limited to a small size.

FIG. 4(A) is a plan view of a transparent substrate 51 included in microchip 5, FIG. 4(B) is a plan view of a transparent substrate 52 included in microchip 5, and FIG. 4(C) is a front view of microchip 5.

Referring to FIG. 4(C), microchip 5 includes a pair of transparent substrates 51, 52. For example, transparent substrates 51, 52 are quartz glass, another glass substrate, or a resin substrate. Transparent substrate 51 and transparent substrate 52 are bonded to each other while overlapped with each other.

As illustrated in FIG. 4(B), electrophoresis capillary grooves 54, 55 crossing each other are formed on the surface of transparent substrate 52. Capillary groove 55 constitutes a separation flow channel 55 for the electrophoresis separation of the sample. Capillary groove 54 constitutes a sample introduction flow channel 54 for introducing the sample into separation flow channel 55. Sample introduction flow channel 54 and separation flow channel 55 constitute an “electrophoresis flow channel”. Sample introduction flow channel 54 and separation flow channel 55 intersect at a crossing position 56.

As illustrated in FIG. 4(A), four through-holes are made in transparent substrate 51 at positions corresponding to the ends of capillary grooves 54, 55. The four through-holes constitute reservoirs 53-1 to 54-4. Hereinafter, sometimes reservoirs 53-1 to 53-4 are collectively referred to as a reservoir 53.

Microchip 5 basically has the configuration in FIG. 4. In order to facilitate handling, as illustrated in FIG. 5, an electrode terminal at which the electrophoresis voltage is applied can be formed on microchip 5. FIG. 5 is a plan view of microchip 5.

Referring to FIG. 5, four reservoirs 53-1 to 53-4 constitute ports at which voltage is applied to electrophoresis flow channels 54, 55. A port #1 (reservoir 53-1) and a port #2 (reservoir 53-2) are located at both ends of sample introduction flow channel 54. A port #3 (reservoir 53-3) and a port #4 (reservoir 53-4) are located at both ends of separation flow channel 55. In order to apply voltage to each of ports #1 to #4, four electrode patterns 61 to 64 are formed on the surface of microchip 5 (transparent substrate 51). Electrode patterns 61 to 64 are formed so as to extend from corresponding ports to end measurement portions of microchip 5, and are connected to high-voltage power supplies 26-1 to 26-4 (see FIG. 2).

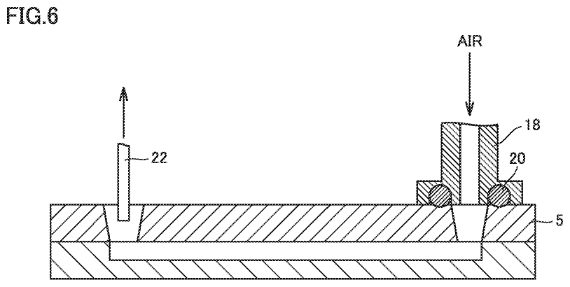

FIG. 6 is a view schematically illustrating a connection state between air supply port 18 of a separation buffer filling and discharging unit 16 and microchip 5.

Referring to FIG. 6, an O-ring 20 is provided at a tip of air supply port 18. By pressing air supply port 18 against one reservoir 53 of microchip 5, air supply port 18 can be attached to electrophoresis flow channels 54, 55 of microchip 5 in the airtight manner. Thus, the air can be pressurized from air supply port 18 and sent into electrophoresis flow channels 54, 55. Suction nozzle 22 is inserted into reservoir 53, and the unnecessary separation buffer liquid or cleaning liquid overflowing from electrophoresis flow channels 54, 55 is sucked and discharged.

[Microchip Electrophoresis Method]

An electrophoresis method executed in microchip electrophoresis device 100 of the embodiment will be described below.

In microchip electrophoresis device 100, microchip 5 is repeatedly used while fixed to holding unit 7. Controller 38 of microchip electrophoresis device 100 executes a program stored in ROM 62 to execute the microchip electrophoresis method of the embodiment.

The microchip electrophoresis method of the embodiment includes a cleaning process of cleaning microchip 5 and an analysis process by the electrophoresis separation in microchip 5. The analysis process is repeatedly executed for each microchip 5. The cleaning process is executed at least once for each microchip 5 at arbitrary timing in a plurality of analysis processes.

(1) Cleaning Process

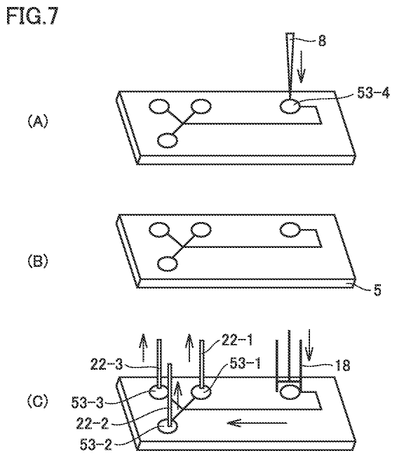

With reference to FIG. 7, the processing procedure of the cleaning process will be described. FIG. 7 is a perspective view illustrating the cleaning process in process order.

Referring to FIG. 7(A), cleaning is executed on microchip 5 in which electrophoresis flow channels 54, 55 and reservoir 53 are empty. Dispensing probe 8 is moved onto reservoir 53-4, and a cleaning liquid is dispensed. Water or a cleaning liquid other than water (such as a cleaning liquid containing an organic solvent or a surfactant), and various cleaning liquids can be used as the cleaning liquid. The dispensing amount of the cleaning solution can be previously set in control device 70 or controller 38 as a cleaning condition.

Referring to FIG. 7(B), microchip 5 is held for a predetermined time while the cleaning liquid is dispensed into reservoir 53-4. In this state, the cleaning liquid dispensed into reservoir 53-4 is introduced into electrophoresis flow channels 54, 55 by the capillary phenomenon. The predetermined time can be previously set in control device 70 or controller 38 as the cleaning condition.

Referring to FIG. 7(C), after a lapse of the predetermined time, air supply port 18 of separation buffer filling and discharging unit 16 is pressed onto reservoir 53-4 in the airtight manner, and the pressurized air is supplied from reservoir 53-4 to the electrophoresis flow channels 54, 55. Suction nozzles 22-1 to 22-3 are inserted into other reservoirs 53-1 to 53-3, respectively, and the cleaning liquid pushed out from electrophoresis flow channels 54, 55 to reservoirs 53-1 to 53-3 is sucked and removed.

In the cleaning process, a series of processes in FIGS. 7(A) to 7(C) is set as one cycle, and the one cycle is repeatedly executed a predetermined number of times. The number of repetitions can be previously set in control device 70 or controller 38 as the cleaning condition.

(2) Analysis Process

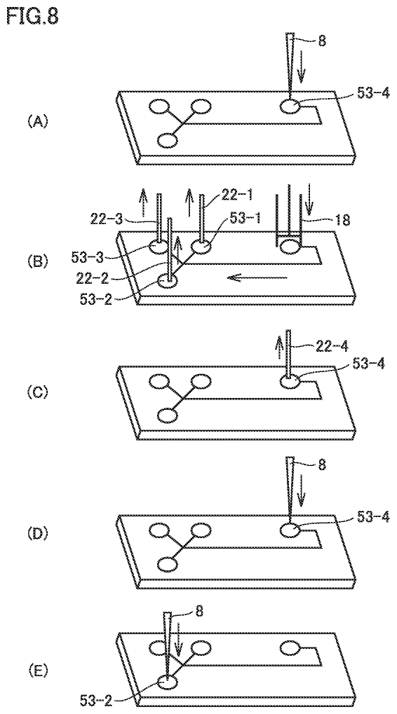

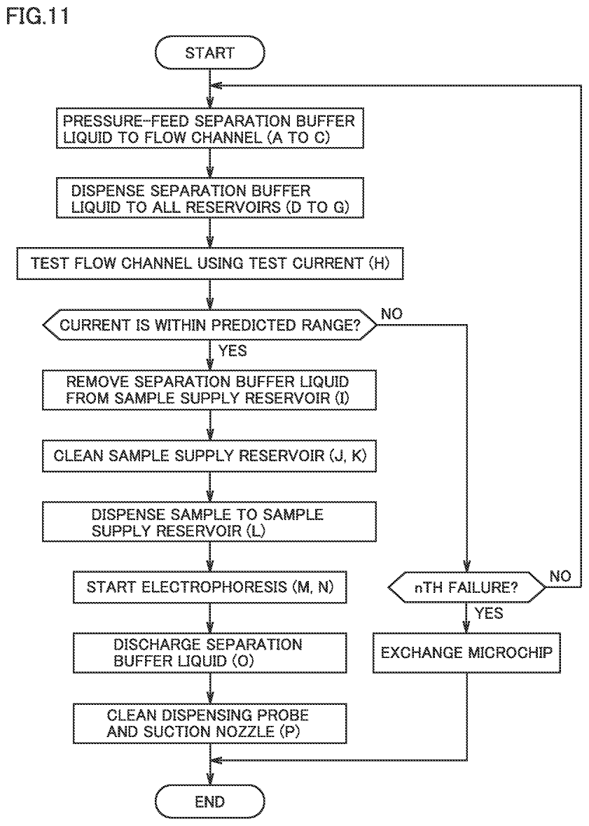

With reference to FIGS. 8 to 11, the analysis process by the electrophoresis separation in microchip 5 will be described below. FIGS. 8 to 10 are perspective views illustrating the analysis process in process order. FIG. 11 is a flowchart illustrating a processing procedure of the analysis process. Reference numerals A to P in the flowchart of FIG. 1 correspond to reference numerals A to P of the processes of FIGS. 8 to 10, respectively.

The analysis process is repeatedly executed for each microchip 5. In the following processing, microchip 5 for the first analysis process or microchip 5 in a state in which the separation buffer liquid is discharged from microchip 5 used in the previous analysis process is used.

Referring to FIG. 8(A), dispensing probe 8 is moved onto reservoir 53-4, and the separation buffer liquid is dispensed.

Referring to FIG. 8(B), air supply port 18 is pressed onto reservoir 53-4 in the airtight manner, and suction nozzles 22-1 to 22-3 are inserted into other reservoirs 53-1 to 53-3. The pressurized air is supplied from air supply port 18 to electrophoresis flow channels 54, 55 through reservoir 53-4, and the separation buffer solution overflowing from electrophoresis flow channels 54, 55 to reservoirs 53-1 to 53-3 is sucked and removed by suction nozzles 22-1 to 22-3.

Referring to FIG. 8(C), suction nozzle 22-4 is inserted into reservoir 53-4, and the separation buffer liquid in reservoir 53-4 is sucked and removed. Thus, the separation buffer liquid remains only in electrophoresis flow channels 54, 55.

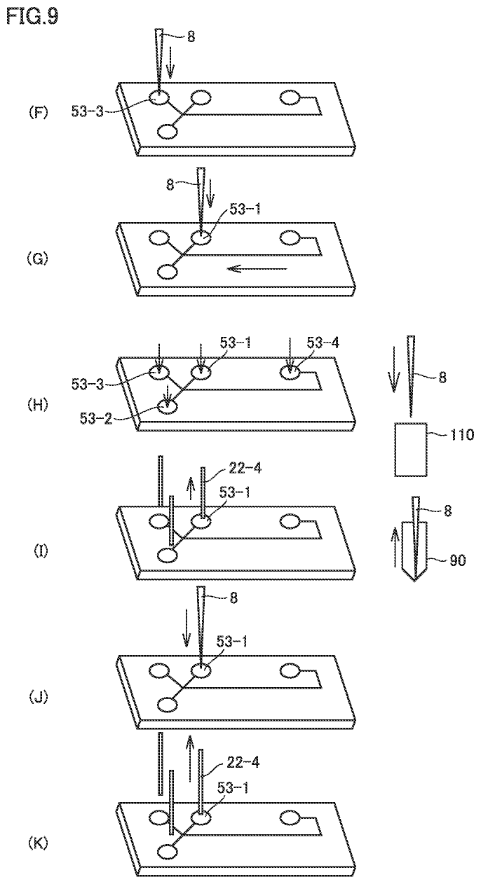

With reference to FIGS. 8(D) and 9(E) to 9(G), the separation buffer liquid is sequentially dispensed to reservoirs 53-1 to 53-4 by dispensing probe 8.

Referring to FIG. 9(H), an electrode is inserted into each of reservoirs 53-1 to 53-4, and an electrophoresis test is executed. In the electrophoresis test, whether dust or air bubbles are mixed in the electrophoresis flow channel is checked by detecting a current value between the electrodes. The voltage applied to the electrophoresis flow channel may be the same as or lower than the electrophoresis voltage for the electrophoresis separation of the sample.

Dispensing probe 8 into which the separation buffer solution is dispensed is introduced into a rinse port 110, the entire amount of the separation buffer solution in dispensing probe 8 is discharged, and the inside and outside of dispensing probe 8 are cleaned.

When determination that the separation buffer liquid is normally filled in the electrophoresis flow channel is made in the electrophoresis test in FIG. 9(H), the analysis process proceeds to the process in FIG. 9(I) in order to inject and analyze the sample. On the other hand, when determination that the separation buffer solution is not normally filled is made in the electrophoresis test, the analysis process returns to the process in FIG. 8(A) in order to refill the electrophoresis flow channel with the separation buffer solution.

The number of times n of allowing refilling of the separation buffer liquid into the electrophoresis flow channel is previously set. When determination that the separation buffer solution is normally filled is not made in the electrophoresis flow channel even after the separation buffer solution is refilled the number of times n, microchip 5 is removed from holding unit 7 and replaced with another microchip 5, and then the process of FIG. 8(A) is started. The number of times n is not particularly limited, but for example, is set to n=2 or 3.

Referring to FIG. 9(I), suction nozzle 22-1 is inserted only into sample supply reservoir 53-1, and the separation buffer liquid in reservoir 53-1 is sucked and removed.

Referring to FIG. 9(J), the cleaning liquid is supplied to sample supply reservoir 53-1 by dispensing probe 8.

Referring to FIG. 9(K), suction nozzle 22-1 is inserted into sample supply reservoir 53-1, and the cleaning liquid is sucked and removed.

The processes in FIGS. 9(J), 9(K) are cleaning processes of removing the separation buffer liquid remaining in sample supply reservoir 53-1. The cleaning process may be repeated a plurality of times as necessary.

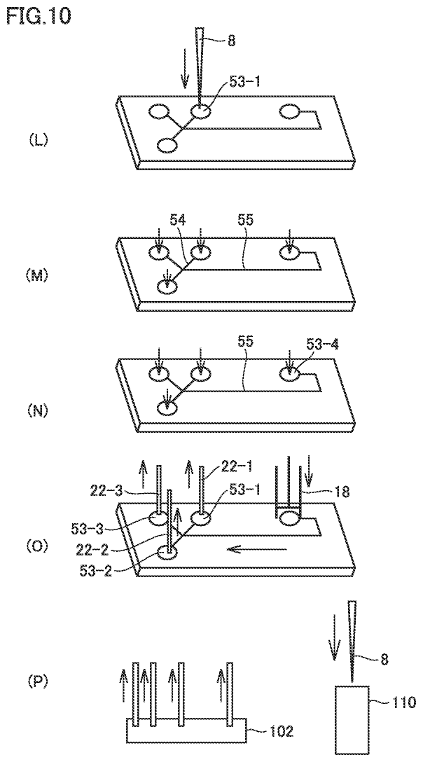

Referring to FIG. 10(L), the sample is injected from dispensing probe 8 into sample supply reservoir 53-1. Optionally, an internal standard substance may be dispensed from dispensing probe 8 to reservoir 53-1 following the sample injection. For example, the internal standard substance includes a low molecular weight marker (LM) and a high molecular weight marker (UM).

Referring to FIG. 10(M), the electrode is inserted into each of reservoirs 53-1 to 53-4, and a sample introduction voltage is applied. Thus, the sample is guided to crossing position 56 between sample introduction flow channel 54 and separation flow channel 55.

Referring to FIG. 10(N), the voltage applied to the electrode is switched to the voltage for electrophoresis separation. The sample is electrophoresis-separated in the direction of reservoir 53-4 in separation flow channel 55 and detected by fluorescence measurement unit 31.

Referring to FIG. 10(O), after the analysis is completed, air supply port 18 is pressed onto reservoir 53-4 in the airtight manner, and suction nozzles 22-1 to 22-3 are inserted into other reservoirs 53-1 to 53-3, respectively. The pressurized air is supplied from air supply port 18 to electrophoresis flow channels 54, 55 through reservoir 53-4, and the separation buffer solution overflowing from electrophoresis flow channels 54, 55 to reservoirs 53-1 to 53-3 is sucked and removed by suction nozzles 22-1 to 22-3.

Referring to FIG. 10(P), each of suction nozzles 22-1 to 22-4 is inserted into a rinse pool 102 to suck the cleaning solution, the inside and outside of the nozzle are cleaned, and dispensing probe 8 is inserted into a rinse port 110 to clean the inside and outside.

The electrophoresis analysis cycle of one sample in one microchip 5 ends by executing processes (A) to (P). When the electrophoresis analysis cycle of a new sample is executed for microchip 5, the analysis process returns to process (A) and the operation is repeated.

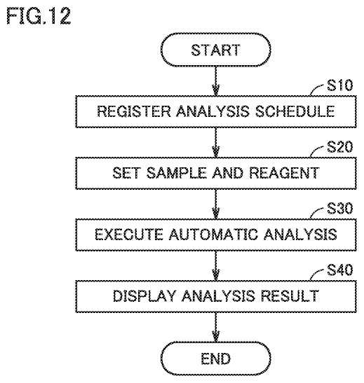

(3) Microchip Electrophoresis Method FIG. 12 is a flowchart illustrating a processing procedure of the microchip electrophoresis method of the embodiment.

(3-1) Analysis Schedule Registration (S10)

Referring to FIG. 12, first, in order to execute the electrophoresis analysis, the analysis schedule analyzing a plurality of samples in order is registered in step S10.

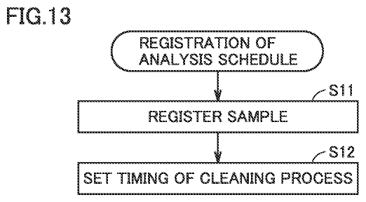

FIG. 13 is a flowchart illustrating a processing flow of analysis schedule registration (S10). Referring to FIG. 13, in the process of registering the analysis schedule, first, a plurality of samples to be analyzed per operation of microchip electrophoresis device 100 is registered (S11). Subsequently, the timing of the process of cleaning microchip 5 is registered (S12). For example, the analysis schedule can be registered using an analysis schedule input screen displayed on display 80.

FIG. 14 is a view illustrating an example of the analysis schedule input screen. Referring to FIG. 14, the analysis schedule input screen schematically illustrates a plan view of microtiter plate 12 as a sample selection screen 200. Microtiter plate 12 has a plurality of wells 12W arranged in a matrix. The measurer can select well 12W storing the sample from the plurality of wells 12W. For example, the measurer can select the sample by clicking corresponding well 12W with a mouse on selection screen 200. When a plurality of samples are selected, the analysis process is repeatedly executed in an automatic analysis process (S30) described later. Microchip electrophoresis device 100 includes the plurality of microchips 5, so that the analysis process can be executed in parallel by processing the plurality of microchips 5 in parallel.

The measurer can set the timing of the cleaning process of each microchip 5 to any timing between a plurality of analysis processes. In the example of FIG. 14, an operation button 210 is displayed on the analysis schedule input screen in order to set the cleaning condition in the cleaning process. When the measurer clicks operation button 210 with the mouse, an operation screen 212 is displayed in order to set the timing of the cleaning process. The measurer can set the timing of the cleaning process using operation screen 212.

In the embodiment, for one microchip 5, the measurer can select and set one of (a) a frequency of executing the cleaning process, (b) an interval of executing the cleaning process, and (c) an allowable value of an electrophoresis separation capability of microchip 5.

(a) Frequency of Executing Washing Process

As the frequency of executing the cleaning process, the measurer can set how many times the cleaning process is executed while repeatedly executing the analysis process a plurality of times for one microchip 5. In this case, when the measurer sets the number of the cleaning processes, the number of analyses executed between two consecutive cleaning processes is determined by dividing the number of times of repetition of the analysis process by the set number of cleaning processes. According to this, in the automatic analysis process (S30) described later, when the analysis process is repeated the determined number of the analyses after the previous cleaning process, the cleaning process is automatically executed.

The measurer can set the frequency of executing the cleaning process according to the number of times of use of one microchip 5, the components of the sample analyzed per operation, the number of samples, the analysis condition, and the like. For example, the frequency of the cleaning process per operation can be increased as the number of times of use of microchip 5 increases. Alternatively, when the sample includes a component that is easily adsorbed on the surface of the electrophoresis flow channel of microchip 5, the frequency of the cleaning process per operation can be increased. By appropriately setting the timing of the cleaning process in this manner, the degradation of the analysis performance can be effectively and efficiently suppressed when microchip 5 is repeatedly used.

(b) Interval of Executing Washing Process

As the interval for executing the cleaning process, the measurer can set the number of analysis processes executed between two consecutive cleaning processes. The cleaning process is different from the cleaning process (a) in that an interval for executing the cleaning process during one operation can be made different.

For example, the number of analysis processes executed between two consecutive cleaning processes can be reduced as the number of times of use of microchip 5 increases. Specifically, the number of analysis processes executed between two consecutive cleaning processes can be set to a first value when the number of times of use of microchip 5 is less than the threshold, and the number of analysis processes executed between two consecutive cleaning processes can be set to a second value less than the first value when the number of times of use of the microchip 5 exceeds the threshold value. In this way, the frequency of the cleaning process increases as the number of times of use of microchip 5 increases, and the degradation of the analysis performance can be suppressed when microchip 5 is repeatedly used.

Alternatively, the number of analysis processes executed between two successive cleaning processes can be decreased as the analysis of the sample proceeds. When the sample includes the component that is easily adsorbed to the surface of the electrophoresis flow channel of microchip 5, the frequency of the cleaning process can be increased as the number of repetitions of the analysis process increases. By appropriately setting the timing of the cleaning process in this manner, the degradation of the analysis performance can be efficiently and effectively suppressed when microchip 5 is repeatedly used.

(c) Allowable Value of Electrophoresis Separation Capability of Microchip 5

The measurer can set the timing of the cleaning process based on the electrophoresis separation capability of microchip 5. In this case, the measurer can set the timing for evaluating the electrophoresis separation capability and the allowable value for determining the electrophoresis separation capability for one microchip 5.

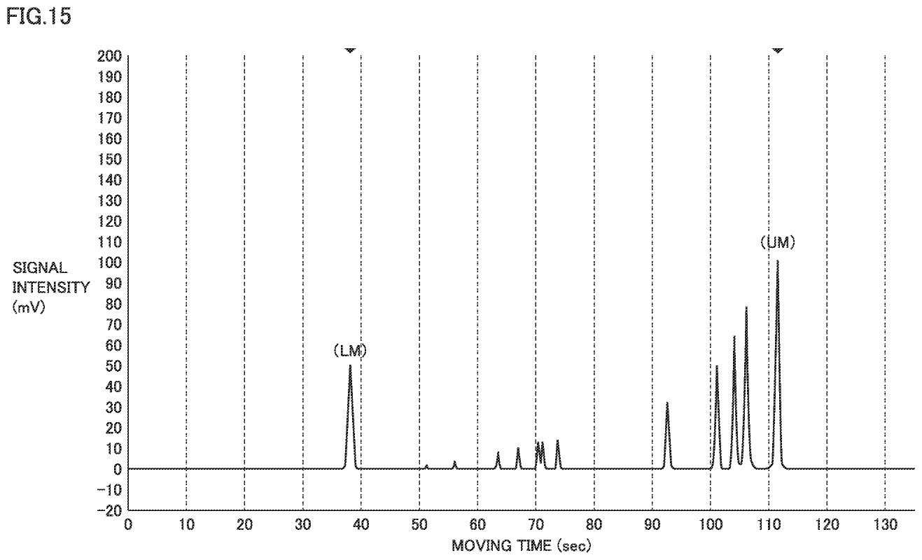

The electrophoresis separation capability of microchip 5 can be evaluated based on the analysis result of the sample in which an internal standard sample (the high molecular marker (UM) and the low molecular marker (LM)) are mixed). FIG. 15 is a view illustrating an example of the analysis result. In FIG. 15, a vertical axis represents signal intensity (unit: mV), and a horizontal axis represents moving time (unit: sec). Two peaks indicated by black triangle marks in the drawing indicate a peak derived from the low molecular marker (LM) and a peak derived from the high molecular marker (UM).

The electrophoresis separation capability of microchip 5 can be evaluated based on theoretical plate numbers and retention times of these two peaks. The theoretical plate number N can be calculated by a half-width method defined by the following equation.

N=5.54(tr/W_{0.5h})²

tr is a retention time of the peak obtained by the electrophoresis analysis, and W_{0.5h} is a half-width of the peak. The retention time is a time from the injection of the sample to the detection of the peak.

In the embodiment, the electrophoresis separation capability of microchip 5 is evaluated based on the theoretical plate number and the retention time of the high molecular marker (UM). The measurer can set the allowable value for each of the theoretical plate number and the retention time using input unit 82. Thus, the timing at which the theoretical plate number of the high molecular marker (UM) falls below the allowable value or the timing at which the retention time of the high molecular marker (UM) exceeds the allowable value can be set as the timing of the cleaning process.

The measurer can also set the evaluation of the electrophoresis separation capability as the timing for evaluating the electrophoresis separation capability of microchip 5 based on the analysis result of which sample among the plurality of samples processed in one microchip 5. In the analysis process of the selected sample, when the sample is dispensed into the sample supply reservoir 53-1 of microchip 5, the high molecular marker (UM) that is the internal standard substance is dispensed.

The timing for evaluating the electrophoresis separation capability of microchip 5 can be set according to the frequency of the evaluations or the interval of the evaluations. Specifically, as the frequency of evaluating the electrophoresis separation capability, the measurer can set how many times the electrophoresis separation capability is evaluated while the analysis process is repeatedly executed a plurality of times for one microchip 5. In this case, when the measurer sets the number of evaluations, the number of analyses executed between two consecutive evaluations is determined by dividing the number of times of repetition of the analysis process by the set number of evaluations. Accordingly, when the analysis process is repeated the determined number of analyses after the previous evaluation, the next evaluation is executed.

The measurer can set the frequency of the evaluations per operation according to the number of times of use of one microchip 5, the components of the sample analyzed per operation, the number of samples, the analysis conditions, and the like. Consequently, the cleaning process can be quickly executed when the decrease in the analysis performance is detected, so that the electrophoresis separation capability of microchip 5 can be quickly recovered.

As the interval for evaluating the electrophoresis separation capability, the measurer can set the number of analysis processes executed between two consecutive evaluations in this case, the interval at which the evaluation is executed during one operation can be made different. For example, the measurer can decrease the number of analysis processes executed between two consecutive evaluations as the number of times of use of microchip 5 increases. Specifically, the number of analysis processes executed between two consecutive evaluations can be set to a first value when the number of times of use of microchip 5 is less than the threshold, and the number of analysis processes executed between two consecutive evaluations can be set to a second value smaller than the first value when the number of times of use of microchip 5 exceeds the threshold. In this way, the frequency of the evaluations increases as the number of times of use of microchip 5 increases, so that the decrease in the analysis performance can be detected to quickly execute the cleaning process.

Alternatively, the number of analysis processes executed between two successive evaluations can be decreased as the analysis of the sample proceeds. When the sample includes the component that is easily adsorbed to the surface of the electrophoresis flow channel of microchip 5, the decrease in the analysis performance can be detected to quickly execute the cleaning process by increasing the frequency of the evaluations as the number of repetitions of the analysis process increases, and as a result, the decrease in the analysis performance can be quickly recovered.

As described above, when microchip 5 is repeatedly used, the decrease in the analysis performance can be efficiently and effectively suppressed by appropriately setting the timing of the cleaning process based on the electrophoresis separation capability of microchip 5.

(3-2) Sample and Reagent Setting (S20)

When the registration of the analysis schedule is completed (S10), the sample and a reagent are set in microchip electrophoresis device 100 in step S20. The reagent includes the separation buffer solution and the internal standard sample (high molecular marker UM, low molecular marker LM). Microtiter plate 12 containing the sample is set in microchip electrophoresis device 100, and the reagent is set in a reagent holder of microchip electrophoresis device 100.

(3-3) Automatic Analysis (S30)

When a start button 220 (see FIG. 14) displayed on the display screen of display 80 is operated by the measurer, the electrophoresis analysis of the plurality of samples is automatically executed. In this process, controller 38 repeatedly executes the analysis process described in (2) above in each microchip 5 according to the previously-registered analysis schedule.

Controller 38 further executes the cleaning process described in (1) above at the previously-set timing between the plurality of analysis processes in each microchip 5.

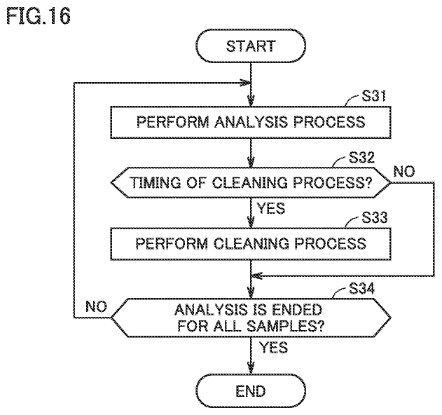

FIG. 16 is a flowchart illustrating a processing flow of the automatic analysis (S30). Referring to FIG. 16, in step S31, controller 38 (electrophoresis controller 92) executes the analysis process for one sample. In step S31, an electrophoresis analysis cycle in FIGS. 8 to 10 is executed.

Subsequently, when the electrophoresis analysis cycle ends for one sample, controller 38 (analysis scheduler 96) determines whether it is the timing of the cleaning process in step S32. When controller 38 determines that it is the timing of the cleaning process (YES in S32), the automatic analysis process proceeds to step S33, and controller 38 (cleaning controller 94) executes the cleaning process.

On the other hand, when controller 38 determines it is not the timing of the cleaning process (NO in S32), the automatic analysis process proceeds to step S34, and controller 38 (analysis scheduler 96) determines whether the analysis process is completed for all the samples.

When the analysis process is not completed for all the samples (NO in S34), the automatic analysis process returns to the analysis process in step S31. Controller 38 (electrophoresis control unit 92) executes the analysis process for the next sample. When the analysis process is completed for all the samples (YES in S34), controller 38 (analysis scheduler 96) ends the automatic analysis process (S30).

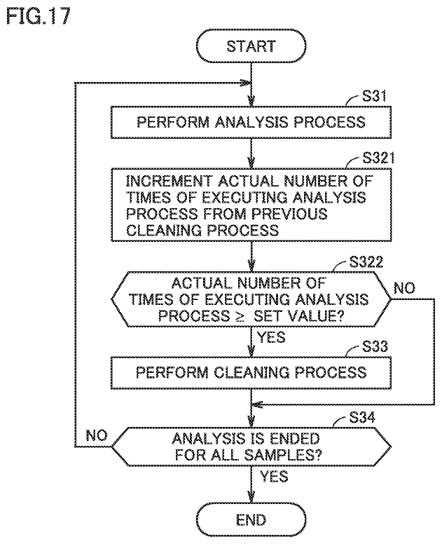

FIG. 17 is a flowchart illustrating a first example of the processing of step S32 in FIG. 16. Referring to FIG. 17, when the analysis process ends in one microchip 5, controller 38 (analysis scheduler 96) increments the actual value (actual number) of the number of times of executing the analysis process after the previous cleaning process in step S321. In step S322, controller 38 (analysis scheduler 96) determines whether the actual number of times of the analysis process is greater than or equal to a set value. The “set value” in step S322 is based on the frequency of the cleaning process or the interval of the cleaning process set in the analysis schedule registration (step S10 in FIG. 12).

When the actual number of times of the analysis process is greater than or equal to the set value (YES in S322), controller 38 (analysis scheduler 96) determines that it is the timing of the cleaning process, and executes the cleaning process of step S33. On the other hand, when the actual number of times of the analysis process is less than the set value (NO in S322), controller 38 (analysis scheduler 96) determines that it is not the timing of the cleaning process, and determines whether the analysis process is ended for all the samples in step S34.

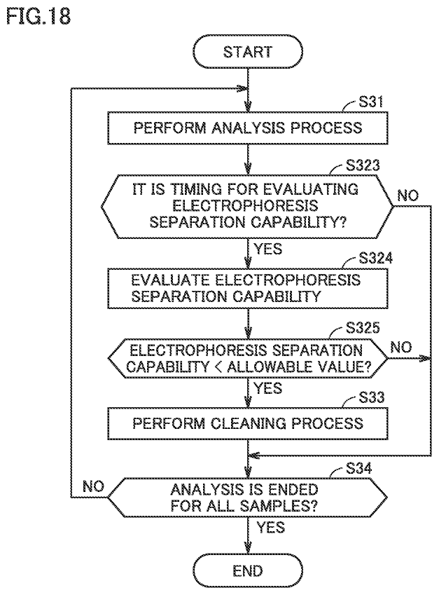

FIG. 18 is a flowchart illustrating a second example of the processing of step S32 in FIG. 16. Referring to FIG. 18, when the analysis process ends in one microchip 5, controller 38 (analysis scheduler 96) determines whether it is the timing for evaluating the electrophoresis separation capability of microchip 5 in step S323. The determination in step S323 is based on the frequency of the evaluations or the interval of the evaluations of the electrophoresis separation capability set in the registration of the analysis schedule (step S10 in FIG. 12).

When determining that it is time for evaluating the electrophoresis separation capability of microchip 5 (YES in S323), controller 38 (analysis scheduler 96) evaluates the electrophoresis separation capability of microchip 5 in step S324. Specifically, in cooperation with control device 70 (data processing unit 86), controller 38 calculates the theoretical plate number and the retention time of the high molecular marker (UM) that is of the internal standard substance from the analysis result of the sample.

In step S325, controller 38 determines whether the electrophoresis separation capability of microchip 5 falls below the allowable value. Specifically, controller 38 determines whether at least one of the theoretical plate number and the retention time of the high molecular marker (UM) falls below the allowable value. Controller 38 determines that the electrophoresis separation capability of microchip 5 falls below the allowable value when at least one of the theoretical plate number and the retention time of the high molecular marker (UM) falls below the allowable value, and controller 38 determines that the electrophoresis separation capability of microchip 5 is greater than or equal to the allowable value when both the theoretical plate number and the retention time of the high molecular marker (UM) are greater than or equal to the allowable value.

When determining that the electrophoresis separation capability of microchip 5 falls below the allowable value (YES in S325), controller 38 (analysis scheduler 96) determines that it is the timing of the cleaning process, and executes the cleaning process of step S33. On the other hand, when determining that the electrophoresis separation capability of microchip 5 is greater than or equal to the allowable value (NO in S325), controller 38 (analysis scheduler 96) determines that it is not the timing of the cleaning process, and determines whether the analysis process is completed for all the samples in step S34.

(4) Display of Analysis Result (S40)

Returning to FIG. 12, when the automatic analysis (S30) of the plurality of samples is completed, control device 70 displays the analysis result on the display screen of display 80. The process of displaying the analysis result (S40) is not limited to the configuration in which the analysis results are displayed when the analysis of all the samples is completed, but the analysis results may be displayed in order from the sample for which the analysis is completed.

[Aspects]

It is understood by those skilled in the art that the plurality of embodiments described above are specific examples of the following aspects.

(Clause 1) A microchip electrophoresis method includes sequentially analyzing a plurality of samples by repeating an analysis process by electrophoresis separation in a microchip (5) (S31), executing a cleaning process of the microchip (5) (S33), and setting timing of the cleaning process of the microchip (5) at arbitrary timing between a plurality of analysis processes (S12).

According to the microchip electrophoresis method described in Clause 1, the timing of the microchip cleaning process can be arbitrarily set, so that the measurer can appropriately set the timing of the cleaning process according to the number of times of use of the microchip, the component of the sample analyzed per operation, the number of samples, the analysis conditions, and the like. Consequently, the efficiency of the analysis work can be improved while the degradation of the analysis performance is suppressed.

(Clause 2) In the microchip electrophoresis method described in Clause 1, the setting the timing of the cleaning process (S12) includes receiving an input operation for giving an instruction on the timing of the cleaning process.

According to the microchip electrophoresis method described in Clause 2, the timing of the cleaning process can be arbitrarily set by the input operation, so that the convenience of the measurer can be improved.

(Clause 3) The microchip electrophoresis method described in Clause 2 further includes receiving an input operation for setting an analysis schedule for analyzing the plurality of samples in order (S10). The receiving the input operation for setting the analysis schedule (S10) includes the receiving the input operation forgiving an instruction on the timing of the cleaning process (S12).

According to the microchip electrophoresis method described in Clause 3, the timing of the cleaning process can also be set when the analysis schedules of the plurality of samples are set, so that the measurer can appropriately set the timing of the cleaning process in consideration of the analysis performance and the efficiency of the analysis work.

(Clause 4) In the microchip electrophoresis method described in Clause 2 or 3, the receiving the input operation for giving an instruction on the timing of the cleaning process (S12) includes receiving an input operation for specifying, for one microchip (5), a frequency of the cleaning process or a number of the analysis processes executed between two consecutive cleaning processes.

According to the microchip electrophoresis method described in Clause 4, the timing of the cleaning process can be arbitrarily set by the input operation, so that the convenience of the measurer can be improved. In addition, the frequency of the cleaning process can be adjusted according to the number of times of use of the microchip, the components of the sample to be analyzed per operation, the number of samples, the analysis conditions, and the like, so that the degradation of the analysis performance can be efficiently suppressed.

(Clause 5) The microchip electrophoresis method described in Clause 1 further includes further comprising evaluating an electrophoresis separation capability of the microchip (5) at arbitrary timing between the plurality of the analysis processes (S324). In the setting the timing of the cleaning process (S12), timing at which the electrophoresis separation capability of the microchip (5) falls below an allowable value is set to the timing of the cleaning process.

According to the microchip electrophoresis method described in Clause 5, the cleaning process can be performed in accordance with the decrease in the electrophoresis separation capability of the microchip, so that the decrease in the analysis performance can be efficiently and effectively suppressed.

(Clause 6) In the microchip electrophoresis method described in Clause 5, in the evaluating the electrophoresis separation capability of the microchip (5) (S324), at least one of a theoretical plate number and a retention time of a peak derived from an internal standard sample included in an analysis result of the most recent analysis process is evaluated. In the setting the timing of the cleaning process (S12), the timing of the cleaning process is set to a time when the theoretical plate number falls below the allowable value or when the retention time exceeds the allowable value.

According to the microchip electrophoresis method described in Clause 6, the cleaning process can be performed in accordance with the decrease in the electrophoresis separation capability of the microchip, so that the decrease in the analysis performance can be efficiently and effectively suppressed.

(Clause 7) In the microchip electrophoresis method described in Clause 5 or 6, the setting the timing of the cleaning process (S12) includes receiving an input operation for setting timing of evaluating the electrophoresis separation capability of the microchip and the allowable value.

According to the microchip electrophoresis method described in Clause 7, the timing and evaluation criterion of evaluating the electrophoresis separation capability of the microchip can be arbitrarily set, so that the convenience of the measurer can be improved.

(Clause 8) A microchip electrophoresis device (100) according to an aspect includes a microchip (5) on which an electrophoresis flow channel (54, 55) is formed, a dispensing probe (8), a moving mechanism (2), a filling and discharging unit (16), and a controller (38). The dispensing probe (8) is configured to inject a separation medium, a sample, and a cleaning liquid into the electrophoresis flow channel (54, 55) of the microchip (5). The moving mechanism (2) moves the dispensing probe (8) between suction positions of the separation medium, the sample, and the cleaning liquid and a dispensing position on the microchip (5). The filling and discharging unit (16) is configured to fill the separation medium and the cleaning liquid into the electrophoresis flow channel (54, 55) and discharges the separation medium and the cleaning liquid from the electrophoresis flow channel (54, 55). The controller (38) controls operations of the dispensing probe (8), the moving mechanism (2), and the filling and discharging unit (16). The controller (38) is configured to repeatedly execute an analysis process (S31) by electrophoresis separation in the microchip (5) and execute a cleaning process (S33) of the microchip (5). The controller (38) is communicably connected to an input unit (82) that receives an input operation for setting timing of the cleaning process (S33) of the microchip (5) at arbitrary timing between a plurality of analysis processes (S31).

According to the microchip electrophoresis analysis device described in Clause 8, the timing of the cleaning process of the microchip can be arbitrarily set through the input unit, so that the measurer can appropriately set the timing of the cleaning process according to the number of times of use of the microchip, the components of the sample analyzed per operation, the number of samples, the analysis conditions, and the like. Consequently, the efficiency of the analysis work can be improved while the degradation of the analysis performance is suppressed.

For the above-described embodiments, it is planned from the beginning of the application to appropriately combine the configurations described in the embodiments within a range in which no inconvenience or contradiction occurs including combinations not mentioned in the specification.

It should be considered that the disclosed embodiment is an example in all respects and not restrictive. The scope of the present invention is defined by not the description above, but the claims, and it is intended that all modifications within the meaning and scope of the claims and their equivalents are included in the present invention.

### REFERENCE SIGNS LIST

2: dispenser (moving mechanism); 4: syringe pump, 5, 5-1 to 5-4: microchip; 6: three-way solenoid valve; 7: holding unit; 8: dispensing probe; 10: container; 12: microtiter plate; 12W: well; 14: cleaning unit: 16: separation buffer filling and discharging unit; 18: air supply port; 20: O-ring; 22: suction nozzle; 23: suction pump unit; 26: high-voltage power supply; 30-1 to 30-4: LED: 31: fluorescence measurement unit; 32-1 to 32-4: optical fiber; 34-1, 34-2 filter; 36: photomultiplier tube; 38 controller; 51, 52: transparent substrate; 54: electrophoresis flow channel (sample introduction flow channel); 55: electrophoresis flow channel (separation flow channel); 56: crossing position; 60, 72: CPU; 61 to 64: electrode pattern; 62, 76: ROM; 64, 74: RAM; 70: control device; 80: display; 82: input unit, 86: data processing unit; 92: electrophoresis controller; 94: cleaning controller; 96: analysis scheduler; 100: microchip electrophoresis device; 102: rinse pool; 110: rinse port; 200: selection screen; 210: operation button; 220: operation screen

1. A microchip electrophoresis method comprising:
sequentially analyzing a plurality of samples by repeating an analysis process by electrophoresis separation on a microchip;
executing a cleaning process of the microchip; and
setting timing of the cleaning process of the microchip at arbitrary timing between a plurality of times of the analysis process; and
evaluating an electrophoresis separation capability of the microchip at arbitrary timing between the plurality of the analysis processes, wherein
the setting the timing of the cleaning process includes receiving an input operation for setting timing of evaluating the electrophoresis separation capability of the microchip, and
in the setting the timing of the cleaning process, a timing at which the electrophoresis separation capability of the microchip falls below an allowable value is set to the timing of the cleaning process.

2. The microchip electrophoresis method according to claim 1, wherein the setting the timing of the cleaning process includes receiving an input operation for giving an instruction on the timing of the cleaning process.

3. The microchip electrophoresis method according to claim 2, further comprising receiving an input operation for setting an analysis schedule for analyzing the plurality of samples in order,
wherein the receiving the input operation for setting the analysis schedule includes the receiving the input operation for giving an instruction on the timing of the cleaning process.

4. The microchip electrophoresis method according to claim 2, wherein the receiving the input operation for an instruction on the timing of the cleaning process includes receiving an input operation for specifying, for one microchip, a frequency of the cleaning process or a number of the analysis processes executed between two consecutive cleaning processes.

5. (canceled)

6. The microchip electrophoresis method according to claim 1, wherein in the evaluating the electrophoresis separation capability of the microchip, at least one of a theoretical plate number and a retention time of a peak derived from an internal standard sample included in an analysis result of the most recent analysis process is evaluated, and
in the setting the timing of the cleaning process, the timing of the cleaning process is set to a time when the theoretical plate number falls below the allowable value or when the retention time exceeds the allowable value.

7. The microchip electrophoresis method according to claim 1, wherein the setting the timing of the cleaning process includes receiving an input operation for setting the allowable value.

8. A microchip electrophoresis device comprising:
a microchip in which an electrophoresis flow channel is formed;
a dispensing probe that injects a separation medium, a sample, and a cleaning liquid into the electrophoresis flow channel of the microchip;
a moving mechanism that moves the dispensing probe between suction positions of the separation medium, the sample, and the cleaning liquid and a dispensing position on the microchip;
a filling and discharging unit that fills the separation medium and the cleaning liquid into the electrophoresis flow channel and discharges the separation medium and the cleaning liquid from the electrophoresis flow channel; and
a controller that controls operations of the dispensing probe, the moving mechanism, and the filling and discharging unit,
wherein the controller is configured to repeatedly execute an analysis process by electrophoresis separation in the microchip and execute a cleaning process of the microchip,
the controller is configured to evaluate an electrophoresis separation capability of the microchip at arbitrary timing between the plurality of the analysis processes,
the controller is communicably connected to an input unit that receives an input operation for setting timing of the cleaning process of the microchip at arbitrary timing between a plurality of analysis processes,
the input unit is configured to receive an input operation for setting timing of evaluating the electrophoresis separation capability of the microchip, and
the controller is configured to set timing at which the electrophoresis separation capability of the microchip falls below an allowable value to the timing of the cleaning process.
